(19) United States
(12) Patent Application Publication
(10) Pub. No.: US 2024/0256876 A1
(43) Pub. Date: Aug. 1, 2024

(54) Machine Learning System Enabling Effective Training

(71) Applicant: Graphcore Limited, Bristol (GB)

(72) Inventors: Charles BLAKE, Bristol (GB); Douglas Alexander Harper ORR, Bristol (GB); Carlo LUSCHI, Oxford (GB)

(21) Appl. No.: 18/182,567

(22) Filed: Mar. 13, 2023

Related U.S. Application Data
(60) Provisional application No. 63/481,705, filed on Jan. 26, 2023.

(51) Int. Cl. G06N 3/084; G06N 3/10

(52) U.S. Cl. CPC G06N 3/084; G06N 3/105

(57) ABSTRACT

A machine learning system implements a machine learning model. The system includes at least one layer of processing nodes, each processing node comprising a processor that executes computer readable instructions to perform at least one operation based on one or more inputs received at the processing node. The operation is scaled by a first scaling factor which has been calculated to cause a variance of an output of the at least one operation to have a target variance, for example unit variance or a variance that matches the variance of the input.

### CROSS-REFERENCE TO RELATED APPLICATIONS

The present application claims priority to U.S. Provisional Patent Application No. 63/481,705 filed Jan. 26, 2023, the disclosure of which is hereby incorporated herein by reference.

### TECHNICAL FIELD

The present disclosure relates to processing data in a machine learning computer.

### BACKGROUND

The development of algorithms that efficiently leverage available hardware has been key to the substantial advances seen in deep learning over the last decade. With the increase in size of state-of-the-art models, hardware-efficiency is also motivated by the need to lower the costs of training. These have grown to become substantial—in terms of money, time, and environmental impact. However, with the end of Moore's law and Dennard scaling, increased transistor density can no longer be relied upon to provide a simple path towards greater efficiency, and other techniques must be leveraged.

One such technique is the use of low-precision number formats. The gains to be had here are considerable: compute, memory and bandwidth usage all depend on the bit-width of a format. Recently, mixed precision training has been developed to allow different number formats to be used across the various activations, weights and gradients (collectively: tensors) in the training process. For example, see Micikevicius, Paulius, et al. “Mixed Precision Training.” International Conference on Learning Representations 2018. In such schemes, there is often an efficiency advantage to using low-precision formats for as many tensors as possible.

Low-precision formats must trade off the range of representable values and the precision (corresponding to the interval between represented values). In floating point formats based on IEEE-754, this is controlled by the number of bits in the format that are allocated to the exponent versus mantissa. Such trade-off is visible in FIG. 1, which shows the signal to noise ratio (SNR) of samples from a normal distribution, quantised in FP16 and FP8. The two 8-bit formats “FP8 E4” and “FP8 E5” allocate 4 and 5 exponent bits respectively (with 1 bit of sign and 3 or 2 bits of mantissa). E5 provides greater range at the expense of precision, while E4 reduces the range while providing higher precision.

The limited range and precision of a number format introduces two forms of error: clipping error which is introduced when a value is outside the representable range, and quantisation error which is introduced when a value falls between representable numbers. Both types of error can degrade deep learning training processes. For this reason, techniques that make deep learning training processes more robust to either reduced range and/or quantisation error are vital to enable efficient training with low-precision formats.

A number of approaches are discussed below.

Loss scaling—Reduced range in FP16 and FP8 is particularly challenging for the backward pass (i.e. the back propagation in which weights are adjusted), where standard model-design practices lead to gradients that risk underflow. To combat this, Micikevicius et al. (2018) have observed that the loss can be multiplied by a scalar to increase the scale of gradients, where weight gradients are then divided by the same scalar in the optimiser. This is valid due to the linearity of the backward pass implicit in the chain rule. Loss scaling is often essential to accurate mixed precision training in FP16 and FP8. However, there is no theoretical motivation for the choice of loss scale, which instead must be found empirically. This comes with a number of downsides. Firstly, a hyperparameter sweep must be conducted to find the loss scale value. This can require multiple full runs, as insufficient loss scales may only become apparent later in training. Secondly, it is not clear ahead-of-time what changes require the loss scale to be re-swept. Thirdly, as loss scaling only applies a single, global scaling factor, it has no mechanism to combat differences in scale between gradient tensors. For some models this difference may be too large for effective training.

Automatic loss scaling—The dynamic adjustment of the loss scale during training is termed automatic loss scaling (Kuchaiev, Oleksii, et al. “Mixed-precision training for n1p and speech recognition with openseq2seq.” arXiv preprint arXiv: 1805.10387 (2018)). This can remove the need to sweep the initial loss scale, and combats shifts in tensor distributions during training. Dynamic schemes require the detection of gradient overflows or the collection of tensor statistics as a basis for changing scale. Updates containing overflowed values may have to be dropped, and such schemes do not allow for different scales across tensors.

Per-tensor scaling—To address the inherent scaling difficulties of FP8 training, Micikevicius, Paulius, et al. “FP8 formats for deep learning.” arXiv preprint arXiv:2209.05433 (2022), propose a per-tensor scaling system, re-scaling locally based on runtime statistics. This technique may achieve well-scaled tensors throughout the model. However, it may incur additional compute, memory, bandwidth and cross-device communication costs due to the need to record statistics for multiple tensors. In addition, policies for adjusting scaling factors may require hyperparameter tuning and implementation complexity may increase.

### SUMMARY

The present disclosure addresses certain technical problems. In particular, it addresses the technical problem of enabling a machine learning model to be effectively initialized or trained using low precision number formats, and mixed precision number formats, where the mixed precision includes low precision number formats. Low precision number formats include, for example FP16 and FP8.

The present disclosure relates to a machine learning system comprising a hardware computer configured to execute instructions in a processor comprising one or more processing unit. The instructions may be stored in a memory accessible to the processor. The disclosure further relates to a method of generating a computer program for implementing a machine learning model for execution on a machine learning system. The machine learning model may be a neural network. The present disclosure addresses certain technical problems.

The method and system enable a machine learning model to be implemented such that it can be trained with improved precision and accuracy relative to existing machine learning models of the same number formats.

According to one aspect of the disclosure, there is provided a machine learning system implementing a machine learning model, the system comprising: at least one layer of processing nodes, each processing node comprising a processor configured to execute computer readable instructions to perform at least one operation based on one or more inputs received at the processing node, wherein the at least one operation is scaled by a first scaling factor which has been calculated to cause a variance of an output of the at least one operation to have a target variance.

According to another aspect of the disclosure, there is provided a computer-implemented method comprising: receiving a computational graph, the computational graph comprising: a plurality of nodes, each node of the plurality of nodes corresponding to a computational operation for training a machine learning model, and a plurality of edges, each edge connecting a pair of the nodes and corresponding to an output of a first node of the pair of the nodes and an input to a second node of the pair of the nodes; and inserting a first scaling factor into the computational graph associated with at least one node of the plurality of nodes, the first scaling factor calculated to cause a variance of an output of the at least one node to have a target variance.

According to another aspect of the disclosure, there is provided a non-transitory computer-readable medium comprising computer-executable instructions, the instructions when executed implementing a neural network, wherein the instructions comprise first code embodying at least one scaled operation configured to receive a tensor of weights and a tensor of input activations and to generate a tensor of output activations with a target variance.

### BRIEF DESCRIPTION OF THE DRAWINGS

For a better understanding of the present invention and to show how the same may be carried into effect, reference will now be made by way of example only to the accompanying drawings, in which:

FIG. 1 is a graph illustrating signal-to-noise ratio associated with low precision number formats;

FIG. 2A is a schematic diagram illustrating scaling of a feed forward network layer in an example machine learning system;

FIG. 2B is a histogram of exponent values at initialisation for the feed forward network of FIG. 2A;

FIG. 3 is a table of example unit scaling factors for use in an example machine learning system;

FIG. 4 is a schematic block diagram of a first example computer system;

FIG. 5 is a schematic block diagram of a second example computer system;

FIG. 6 is a schematic block diagram of a third example computer system;

FIG. 7 is a table comparing techniques for low precision training of a machine learning model;

FIG. 8 is a series of code snippets showing implementation of example techniques using PyTorch;

FIG. 9 is a series of graphs illustrating the performance of various models trained using various scaling techniques on a character language modelling task;

FIG. 10 is a table illustrating performance of systems employing example techniques on a masked language modelling task;

FIG. 11 is a table illustrating common floating point representations in deep learning;

FIG. 12 is a code snippet showing implementation of a unit-scaled model in PyTorch;

FIG. 13 is a series of graphs comparing different residual scaling approaches on the character language modelling task;

FIG. 14 is a table setting out hyperparameters used in the character modelling task;

FIG. 15 is a table illustrating results of the character language modelling task using different models and precisions;

FIG. 16 is a table illustrating hyperparameters used in the masked language modelling task;

FIG. 17 is a histogram of absolute tensor values in a model carrying out the masked language modelling using loss scaling at the beginning of training;

FIG. 18 is a histogram of absolute tensor values in a model carrying out the masked language modelling using unit scaling at the beginning of training;

FIG. 19 is a histogram of absolute tensor values in a model carrying out the masked language modelling using loss scaling at the end of training;

FIG. 20 is a histogram of absolute tensor values in a model carrying out the masked language modelling using unit scaling at the end of training, and

FIG. 21 is a schematic block diagram of an example computing system.

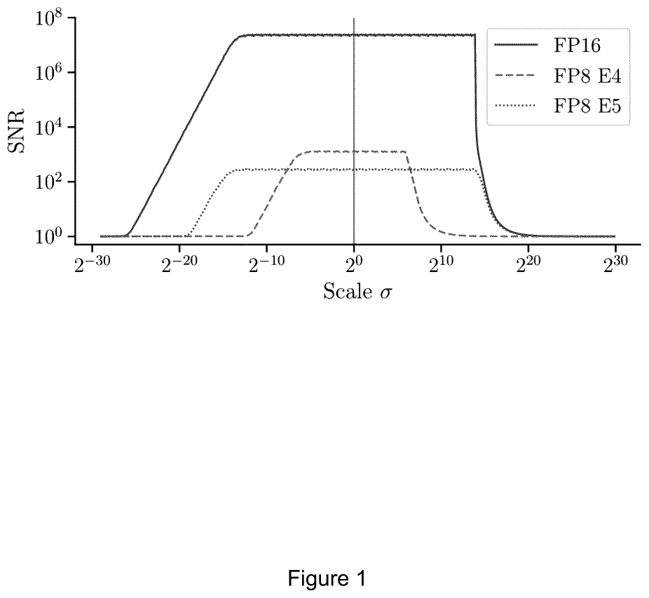

### DETAILED DESCRIPTION OF EXAMPLES

Unit scaling is a paradigm for designing deep learning models that simplifies the use of low-precision number formats. Training in FP16 or the recently proposed FP8 formats offers substantial efficiency gains but can lack sufficient range for out-of-the-box training. Unit scaling addresses this by introducing a principled approach to model numerics: seeking unit variance of all weights, activations and gradients at initialisation. Unlike alternative methods, this approach neither requires multiple training runs to find a suitable scale nor has significant computational overhead. It is effective across a range of models and optimisers and can enable training in FP16 and FP8 out-of-the-box, with no degradation in accuracy. The disclosure herein also provides a procedure for adapting existing models to be unit-scaled. The unit scaling may be extended to other target scales.

Unit scaling addresses the problem identified above of reduced range by attempting to put the model's tensors inside the representable range at initialisation.

For normally distributed tensors the term “scale” is used to refer to standard deviation. There is minimal change (relative to the range of formats) of the mean. Scale therefore characterises the probability of clipping error given a format, as too large or small a scale will lead to values that lie outside of the representable range. The ability to predict the scales of tensors in a deep learning model would provide a powerful tool to address clipping error. This is hard in general, but the problem is simpler at initialisation. Before any training steps, parameters are drawn from known initialisation distributions, so if the input distribution is known, analysis or simulation can derive the scale of each tensor. A further simplification is to make local distributional assumptions for a single layer in the model and consider the propagation of scale through the model. This permits a methodical analysis: first, characterise the scaling effect of each operation independently; second, propagate scales through the computational graph, forwards and backwards.

Since the initial distribution of parameters is directly controlled by the model designer, the dominant approach to scaling is to select initial parameter variance to trade off forward and backward pass variance scaling (Xavier Glorot and Yoshua Bengio. Understanding the difficulty of training deep feedforward neural networks. 13th International Conference on Artificial Intelligence and Statistics, 2010; Kaiming He et al, Delving deep into rectifiers: Surpassing human-level performance on imagenet classification. IEEE International Conference on Computer Vision, 2015.). Such schemes were developed to avoid exploding/vanishing gradients in deep multilayer perceptrons. As such, they do not seek to constrain the scale of parameters and parameter gradients. They are also limited to computations where scale factors can be moved into trainable parameters.

Unit scaling uses similar scale analysis techniques, but inserts scaling factors in the computational graph, rather than modifying the initialisation scale of parameter tensors. This gives an approach which is helpful for controlling the scale of intermediate tensors and is more general than initialisation-based schemes.

Unit scaling is a technique for constructing deep learning models, based on a graph construction recipe that inserts scaling factors into the computational graph that describes the training or inference process. As implied by the name “unit scaling”, the default version of the recipe has the goal of achieving approximately unit scale (i.e. standard deviation=1) of internal tensors and parameters, at initialisation. However, the recipe can be generalised to any target scale and is not necessarily restricted to ‘unit’ scaling.

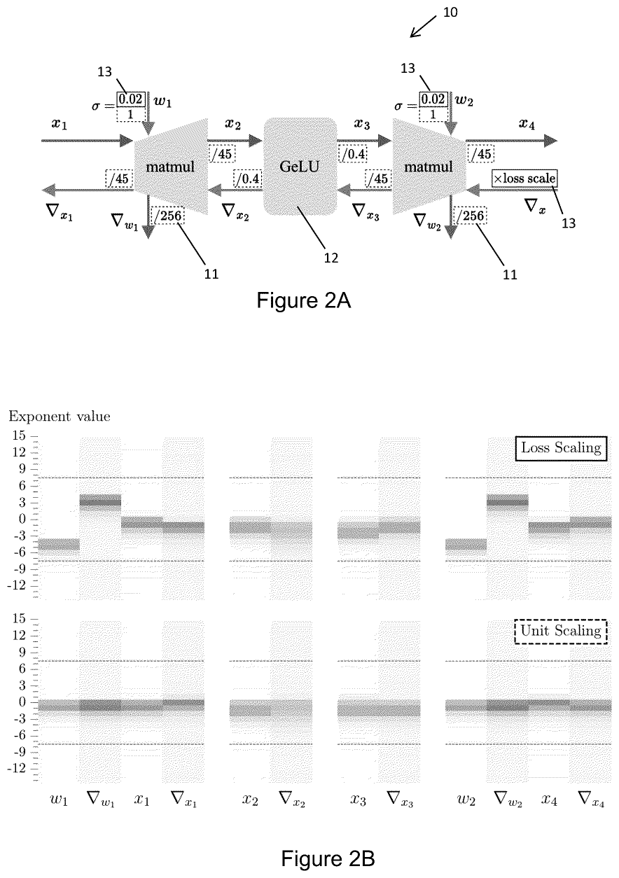

This is accomplished by inserting scaling factors into the forward and backward passes. This is illustrated in FIG. 2A, which shows each tensor of an example feedforward network (FFN) layer 10 of an example machine learning system being multiplied by a fixed scalar to achieve consistent scale. In particular, the dotted rectangles 11 illustrate the fixed scalars applied to the tensors. Not all dotted rectangles are labelled to assist the clarity of the figure. The tensors shown in FIG. 2 are:
x₁, representing an input tensor,
w₁, representing an input weight tensor corresponding to the input tensor,
x₂, representing the matrix multiplication of the weight w₁ and input x₁,
x₃, representing the output activation of the activation function 12 of the layer 10, which is in this case a GeLU function,
w₂, representing an output weight tensor corresponding to the output activation,
x₄, representing the matrix multiplication of the output activation by the output weight;

In addition, the same labels preceded by V represent corresponding gradient tensors.

Solid rectangles 13 in FIG. 2A represent the application of scaling in a loss scaling technique. That is to say, the solid rectangles represent an alternative to the unit scaling technique herein.

FIG. 2B illustrates exponent values of the above tensors at initialisation of the FFN layer 10. In the upper histogram, loss scaling is used. In the lower histogram, unit scaling as discussed herein is used. The shade in the histogram represents the bin density. The y-axis reflects exponent values available in FP16, while dashed lines show the max/min exponents of the FP8 E4 format.

Like loss scaling, the modification of the backward pass still ensures correct gradients up to a constant multiplicative factor. However, unlike loss scaling, unit scaling determines these scales based on a fixed set of rules for each operation, rather than a single hyperparameter to be found empirically, or via an adaptive algorithm. The scales chosen enable each operation to approximately preserve the variance of its inputs. This effect then propagates through the model, giving global unit-scaling. By concentrating values in approximately the centre of the exponent range at initialisation, tensors are given headroom to potentially shift during training without going out-of-range. Note that unit scaling could be used in combination with a system that monitors or adapts certain scaling factors during training.

It will be appreciated that this is merely one example of a suitable neural network layer to which the concepts herein may be applied. As discussed above, unit scaling may be applied to substantially any operations, including in different types of layers (e.g. attention layers) carried out in a neural network.

Inserting the scaling factors into the computational graph may involve storing the scaling factors as an attribute of an existing operation, such that each scaling factor is associated with the relevant operation of the graph. In other words, each node/operation of the graph may comprise a plurality of attributes, of which one is the scaling factor.

Alternatively, it may involve inserting additional operations into the computational graph. This is done by breaking an edge of the graph into two edges, connected by a scaling operation node.

This scaling operation has a single input and a single output and acts to multiply all elements of an input tensor by the same fixed scale.

### Definitions

A “deep learning model” is a differentiable function from inputs and trainable parameters to outputs.
A “computational graph” is a graph of operations (nodes) and tensors (edges) that describes the structure of a computation. The tensors represent the input to and output from the nodes.
   Typically, there is one “forward graph” that implements the model (mapping from inputs and trainable parameters to outputs).
   There are one or more “backward graphs” that implement gradients (e.g. mapping from inputs to parameter gradients).
An “operation” is a mapping from input tensors to an output tensor. Many operations are differentiable to produce gradient operations.
A “scaled operation” is an operation with an additional forward scaling parameter that is multiplied with the output, and an additional backward scaling parameter per input tensor, that is multiplied by the result in any gradient operations.
A “scaling factor” is a scalar value that is multiplied into a tensor to change its' scale.
A “parameter” is a tensor that has an initial value (typically randomly chosen) and is updated during training (typically using a first-order optimiser based on the gradient of a loss).
“Bias” parameters are additive and would typically be initialised to zero.
A “cut edge” is an edge in the forward graph, which if cut would disconnect that edge's head and tail in the graph (i.e. there is no other path from head to tail in the forward graph).

The high-level recipe (i.e. method) for unit scaling disclosed herein is as follows:
1. Initialize non-bias parameters with unit variance and whiten inputs.
2. Calculate scaling factors for all (scaled) operations.
3. Identify non-cut-edges and constrain the operations consuming them to have backward scaling factors that equal the forward scaling factor.
4. Replace additions with weighted additions.

This recipe may be applied completely manually, semi-automatically or fully automatically. In manual mode, the model designer selects initialisation distributions, calculates scaling factors and inserts these scaling factors into the computational graph in accordance with the recipe above. A semi-automatic mode automates parts of this process, while (for example) requiring the model designer to select scaled operation implementations or identify cut edges. Fully automatic mode allows the model designer to enable unit scaling without providing any additional information, where the system selects appropriate initialisation, scaling factors and identifies cut edges automatically.

After applying the recipe, the method produces a unit-scaled computational graph that may be used for training the deep learning model using gradient-based optimisation techniques that are known in the art.

At initialisation, deep learning models may select an initial scale for their parameters. As noted in the background above, models typically select an initialisation scale in order to preserve forward/backward pass scaling. The present technique of unit or target scaling does not require this since scale-preservation is built-in using scaling factors, and instead recommends setting non-bias parameters to have unit scale (standard deviation=1) at initialisation. It does not stipulate the type of distribution that should be used. Bias parameters may be zero-initialised as usual.

Where the inputs to the model are continuous values (i.e. not categorical values, embedded by the model), they should be “whitened” to have zero mean and unit scale. This is a standard procedure, which uses a sample to estimate the mean and standard deviation, then using these fixed values to normalise inputs to have the required statistics.

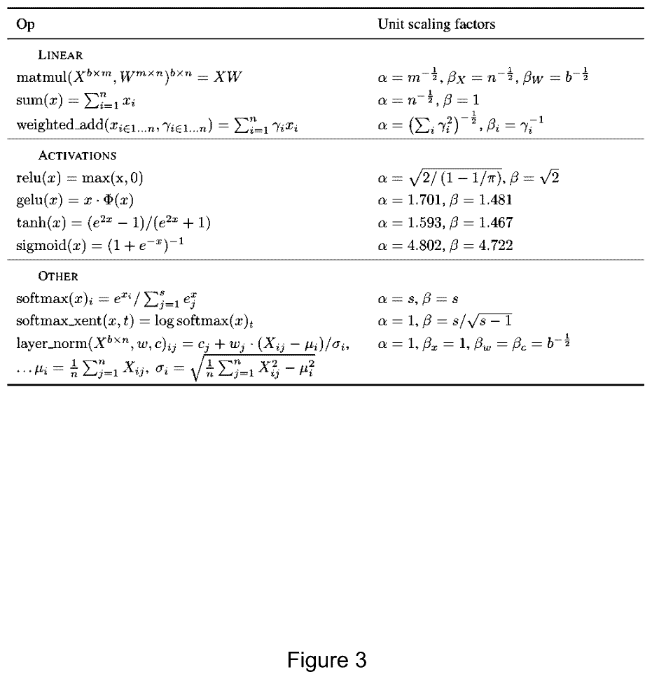

In most cases, forward and backward scaling factors can be calculated locally for each operation, without the need to propagate information about input and output distributions through the graph. In this case, the assumption is made that all inputs are independent and normally distributed, with zero mean and unit (or target) variance, then either by analysis or simulation to derive the output scale. The forward scaling factor is then set to the inverse of that output scale. The same process is repeated for the backward scale. Examples of scaling factors for common operations are given in FIG. 3. The operations include linear operations (e.g. matrix multiplication, sum, weighted addition), activation functions (e.g. ReLU, GeLU, tanh, sigmoid) and other operations such as softmax, softmax cross entropy and layer normalisation.

In some cases, these assumptions may be too strong, and it is better to assume correlated samples or non-zero mean, etc. This will depend on the model being used, and after forming these assumptions, would enables the same process as above to derive the scaling factors.

A key property of unit (or target) scaling in certain embodiments is that it ensures correct gradients up to a constant multiplicative factor. To achieve this property, constraint-scaled computational graphs are introduced, which constrain scaling factors with the following rule: for any edge in the forward graph that is not a cut-edge, require the consuming operation to have backward scaling factor for that input that is equal to the forward scaling factor.

Constraint-scaled computational graphs that obey this rule will also represent a scaled operation, therefore have gradients that are correct up to a constant multiplicative factor. Such gradients ensure that gradient-based optimisation on unit-scaled models is consistent, i.e. that there exists an unscaled computational graph that exhibits the same training dynamics.

Identifying cut edges in a graph permits manual, semi-automatic and automatic modes of operation. In an automatic mode, once the full forward graph is available, the cut edges may be identified by a graph search algorithm. In semi-automatic mode, the model designer would defines the model via an API that might assume that parameters are cut-edges, but that activations are not cut-edges by default (both with the option for the user to override them, since shared parameters do not imply cut-edges and some activations may be cut edges). After calculating unconstrained cut-edge scaling factors as above, a constraint-scaled operation is created by taking each constrained group including the forward scaling factor and any backward scaling factors corresponding to non-cut edges and setting them all equal to the geometric mean of the group. This will mean that the output and input gradient scales can deviate from unit scale, however this trade-off is required in order to maintain correct scaled gradients in the whole graph.

For the most part, the scale of tensors at initialisation in unscaled deep learning models does not play a critical role. A notable exception is when tensors of different scales are added, for example residual layers, losses and positional encodings. If these addition operations to unit-scaled equivalents are naively converted, they place equal weight on their inputs, which can be detrimental to performance. Accordingly, to resolve this weighted addition is used (see the “weighted_add” operation of FIG. 3). This introduces new hyperparameters into the model, which can be chosen by design principle, empirically by sweep, or selected to match a reference model.

For residual layers, there are existing design principles in literature. For example, the following residual layers based on NF-ResNets (see Brock, A., De, S., Smith, S. L. and Simonyan, K. (2021) High-Performance Large-Scale Image Recognition Without Normalization. Proceedings of the 38^{th} International Conference on Machine Learning) which transform the activation at x₁ to xₗ₊₁:
Default: xₗ₊₁=xₗ+f(xₗ) (this is not suitable for unit scaling)
Fixed (τ): xₗ₊₁=\sqrt{1−τ·}xₗ+\sqrt{τ}·f(xₗ)
Running-mean: xₗ₊₁=\sqrt{l/(l+1)}·xₗ+\sqrt{1/(l+1)}·f(xₗ)

An issue with these weighting rules is that they may produce small gradient scales in the residual branch, which is not a cut-edge and so cannot be independently rescaled. To resolve this, examples herein perform a special-case rewrite to replace γ·f(x) with id*(f(id*(x, 1, γ)), γ, 1), where id*(x, α, β) is the scaled identity function with forward scaling factor α and backward scaling factor β, which maps x→α·x in the forward pass and g→β·g in the backward pass. This maintains unit scale for the backward pass of f, while preserving correctly scaled gradients for the constraint-scaled computational graph.

Unit scaling is described above as a procedure for constructing new models. However, it may also be applied where there is a requirement to match the behaviour of an existing (baseline) model. There are three principal areas where differences arise:
1. Non-linear operations.
2. Multi-input operations (except product).
3. Optimiser step size.

Non-linear operations—Deep learning models typically include various non-linear operations such as softmax, GELU and tanh. The behaviour of a non-linear operation may depend on the scale of its input. Since the baseline model inputs may not have unit scale, the unit-scaled model inputs may explore a different region of the non-linear function, giving rise to different behaviour. To combat this, one can introduce a scaling factor immediately before an activation function (temporarily breaking unit scale), and a second un-scaling factor immediately afterwards (restoring unit scale). The first scaling factor is chosen to match the input scale in the baseline model, determined either empirically or analytically, and the second is chosen to restore unit scale, given inputs of that scale (also empirical or analytical).

Multi-input operations—Operations such as addition are sensitive to the relative scales of their inputs. These scales may vary across inputs in the baseline model yet should all be approximately =1 in a unit-scaled model. To counteract this difference, in a similar vein to non-linear operations, weights can be determined (relative scaling factors) to apply to each input, to match the relative contributions of inputs between the baseline model and a unit-scaled model, while maintaining that the output has unit scale. These weights may be determined empirically or analytically.

Optimiser step size—Unit scaling guarantees gradients that are scaled versions of an unscaled model's parameter gradients. With this property, training dynamics (the evolution of loss and parameters over training) may still vary between the baseline and the converted unit-scaled model, for two reasons. First, the optimiser may be sensitive to rescaling of the gradients, for example SGD (with or without momentum) but not Adam. Second, the model with equivalent training dynamics may be different to the baseline model that was converted—in particular, it may be a reparameterisation. To address both differences, the optimiser step size may be modified per parameter tensor. These step sizes may be computed analytically, by considering the product of all forward scaling factors between parameter and loss, and similarly the product of all backward scaling factors between loss and parameter. The same recipe can be adapted to obtain an arbitrary scale target s. To do this, source nodes are modified to generate tensors with scale s, and operations to preserve scale s given inputs of that scale. For the former, parameters are initialised with scale s, and inputs are whitened to have scale s. For the latter, no change is required for linear operations such as matmul or weighted_add, but for nonlinear operations the analysis would need to be extended, or simulation to be repeated.

This can be performed for fresh unit-scaled models, or when adapting existing baseline models, as above. It allows the choice of a global numerical starting point, which may be useful to reduce clipping error if values are known to shift during training, or quantisation error in number formats with non-uniform signal to noise ratio over their represented range.

Unit scaling is a procedure that is applied to the computational graph for training deep learning models, with a low up-front computational cost to do so (finding cut-edges and computing scaling factors do not involve significant computation). However, the runtime and memory efficiency of executing the resulting computational graph is of high importance, since the goal of using low-precision formats is to save runtime, memory or both.

The only modification of a baseline computational graph when using unit scaling is the inclusion of a scaling factor per forward pass operation, and one per backwards pass operation (assuming one backwards pass operation per input). In large models with large dense matmuls (e.g. Transformer, ResNet), the number of scalar operations (e.g. floating point operations, FLOPs) of such elementwise scaling operations is negligible. However, the cost of executing them as separate kernels on devices with attached RAM, where each kernel involves a round-trip to RAM, may be more significant. It is therefore useful to consider automatic or manual fusing of scaling operations into adjacent kernels, so that the additional overhead is minimised.

Unit scaling with fused kernels may also reduce the need to write single precision intermediate values to RAM or across a network, since the scaling factor may be applied early enough to bring the values written/communicated into unit scale. Care would still have to be taken to mitigate the effects of quantisation error, however.

As discussed above, unit (or target) scaling provides the following technical advantages:
1. Aiming to achieve a global target scale for tensors (activations, gradients and parameters) at initialisation.
2. The ability to select different scaling factors in the forward and (one or more) backward passes.
3. Local analysis or simulation of operations to derive scaling factors under assumptions on their input distributions.
4. Global graph analysis to add scaling constraints between forward and backward passes, which ensure that gradients are correct up to a constant scale.
5. The ability (but not requirement) to match existing models' training dynamics using non-linearity scaling, multi-input weighting and per-tensor step size.
6. The ability (but not requirement) to generate fused operations with a constant output scale factor.

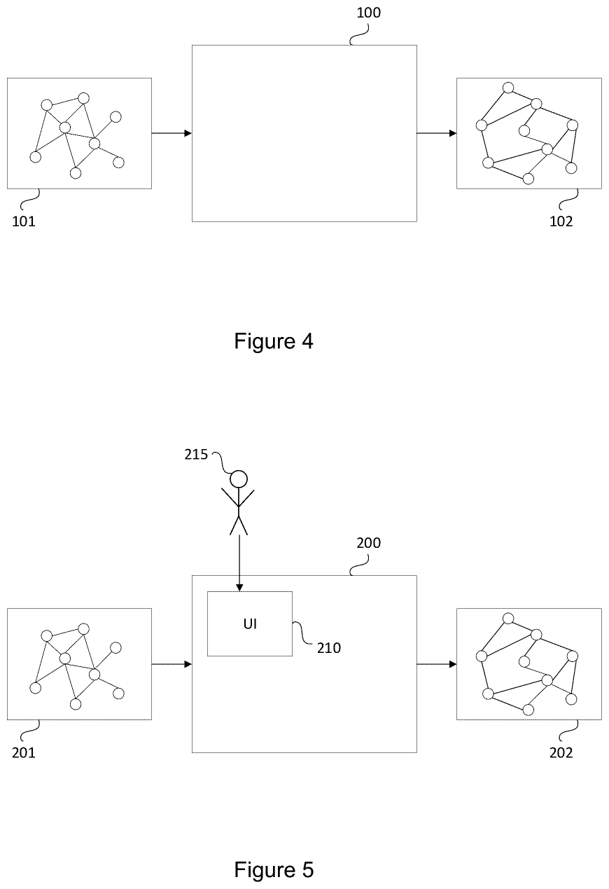

FIG. 4 shows an example computer system 100. The computer system 100 is configured to receive as input a computational graph 101. As discussed herein, the computational graph 101 is a graph (e.g. a directed acyclic graph) of operations (i.e. nodes) and tensors (i.e. edges) that describe the structure of a computation. The computational graph 101 may be a forward graph or backward graph as discussed herein. The input graph 101 is unscaled.

The computer system 100 is further configured to carry out the recipe/method discussed herein above, in the fully automatic mode. For example, the computer system 100 is configured to:
1. Initialize non-bias parameters with unit variance and whiten inputs.
2. Calculate scaling factors for all (scaled) operations.
3. Identify non-cut-edges and constrain the operations consuming them to have backward scaling factors that equal the forward scaling factor.
4. Replace additions with weighted additions.

This results in an output graph 102, in which the tensors are unit-scaled. The input graph 101 and/or output graph 102 may be stored in the memory.

FIG. 5 shows another example computer system 200, which substantially corresponds to the computer system 100 herein apart from as discussed below. Like the computer system 100, the computer system 200 is configured to receive an input (unscaled) computational graph 201 and output a unit scaled computational graph 202. However, in contrast to computer system 100, the computer system 200 comprises a user interface (UI) 210 configured to receive input from a user 215 (i.e. a machine learning model designer).

The UI 210 is configured to receive user input representing one or more of the following:
selection of one or more initialisation distributions for parameters of the model (i.e. the machine learning model represented by the graph 201).
scaling factors for insertion into the computational graph in relevant locations accordance with the recipe above. In other words, the user 215 may calculate the scaling factors themselves and insert them at the relevant locations in the graph using the UI 210.
explicit identification of cut-edge constraints (corresponding to step 3 in the description of computer system 100 above).
selection of one or more weighting hyperparameters for weighted add operations (inserted according to step 4 in the description of computer system 100 above).
selection of one or more per-parameter optimiser step size modifiers, used to scale the global optimiser step size hyperparameter.

In some examples, however, the UI 210 is configured to automate at least some parts of the process. For example, the user 215 may only be required to select scaled operation implementations or identify cut (or non-cut) edges.

The computer system 200 is then configured to generate the unit-scaled computational graph 202 based on the user input received via UI 210.

The UI 210 may broadly comprise any suitable means of interaction with a user 215, including mouse and keyboard, displays, touch screens, audio interfaces and the like. It also encompasses means of receiving user input over a suitable network connection—for example in the case that the system 200 is a web-based (e.g. cloud hosted) application accessible via another remote device (e.g. a personal computer) operated by the user.

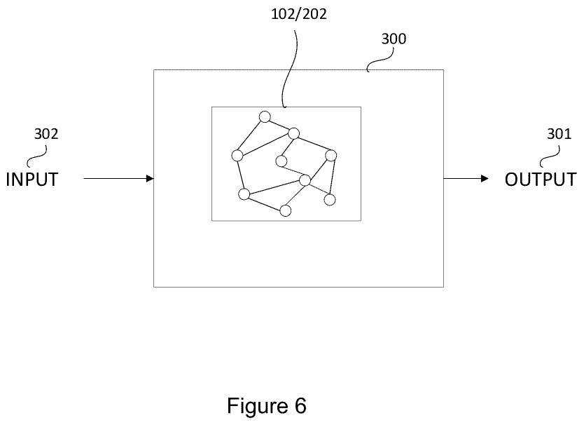

FIG. 6 shows another example computer system 300. The computer system 300 is configured to execute the unit-scaled computational graph 102/202 to provide an output 301. In other words, the computer system 300 is configured to carry out each operation represented by the nodes of the graph 102/202. The computer system 300 can also receive input data 302.

In one example, the computational graph 102/202 is a graph for training a machine learning model. Accordingly, the output 301 in such an example is a trained machine learning model resulting from execution of the computational graph. The trained model may take the form of a plurality of learned parameters that are the output of the training process, such as a set of learned weights.

In order to train the model, the computer system 300 may receive input data 302 in the from of other data and/or parameters in addition to the graph 102/202. This includes one or more of: a training data set, hyperparameters for model training, and parameters for any pretrained model components. The hyperparameters may be hyperparameters that are not represented in the already graph 102/202, such as step size schedule (i.e. the learning rate).

In another example, the computational graph 102/202 is a graph for executing a model trained as discussed above. In other words, the computer system 300 can use the trained model at inference time (i.e. in an inference process). In such an example, the graph is 102/202 is a forward graph, mapping received input data 302 to an output 301. The computer system 300 applies forward scaling factors as discussed herein and the learned parameters that are the output of the training process to graph 102/202.

In such cases, the input data 302 can be broadly considered a query, and the output a response. The nature of the query and the response depends upon the task that the machine learning model is trained to carry out. For example, if the graph 102/202 represents a machine learning model trained for image classification, the query may be an input image. The output may then be a classification label. Alternatively, if the graph 102/202 represents a machine learning model trained for text classification, the query may be input text. The output may then be a classification label for the text. It will be understood these are merely examples of suitable trained machine learning models—the techniques herein are applicable to substantially any input and output modalities, and models other than classification models.

The computer systems 100, 200, 300 each comprise a suitable processor and a memory accessible to the processor. In some examples, the processor includes a plurality of processing units (for example tiles of a tile processor). In some examples, the computer systems 100, 200, 300 each comprise a plurality of processing nodes, wherein each node comprises a processor, each processor optionally including a plurality of processing units. The processing nodes may be arranged in layers in some examples.

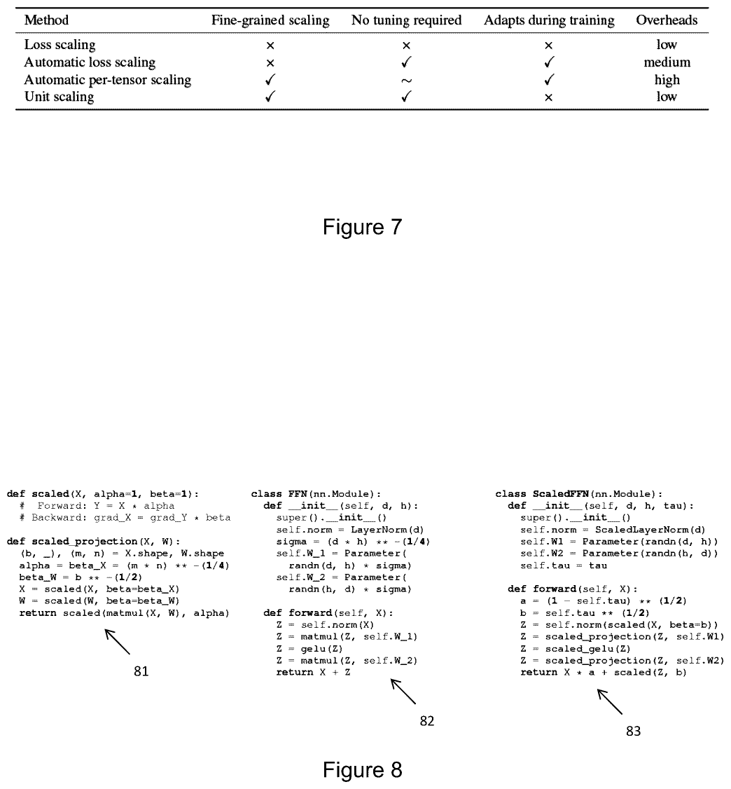

FIG. 7 illustrates features of the unit scaling techniques discussed herein in comparison with the techniques discussed in the background section hereinabove. ‘˜’ indicates that this method ideally requires no tuning, but in practice may introduce hyperparameters that need to be swept. As illustrated, unit scaling permits fine-grained scaling, involves no tuning and has a low overhead.

FIG. 11 illustrates common floating point formats for deep learning, which may be used in conjunction with any of the techniques described herein. E refers to the number of exponent bits, and M the number of mantissa bits of a given format. Max exp. and Min exp. refer to the maximum and minimum values that can be represented by the exponent, excluding special values. E5 (a) and E4 (a) refer to the FP8 formats introduced by Badreddine Noune, et al, 8-bit numerical formats for deep neural networks, arXiv preprint arXiv:2206.02915, 2022. E5 (b) and E4 (b) refer to those introduced by Micikevicius et al. (2022) FIG. 8 shows example code snippets for implementing certain aspects of the techniques discussed herein. In particular, function 81 is a scaled_projection function for carrying out a scaled projection operation. The scaled projection operation implicitly constrains βₓ. Class 82 is an unscaled FFN layer of a transformer model. Class 83 is a unit-scaled FFN layer. Compared with the unscaled layer 82, the scaled FFN layer 83 initializes the weights with unit scale, replaces unscaled operations with scaled operations, and replaces residual addition with interpolation according to tau, moving the backward pass scale.

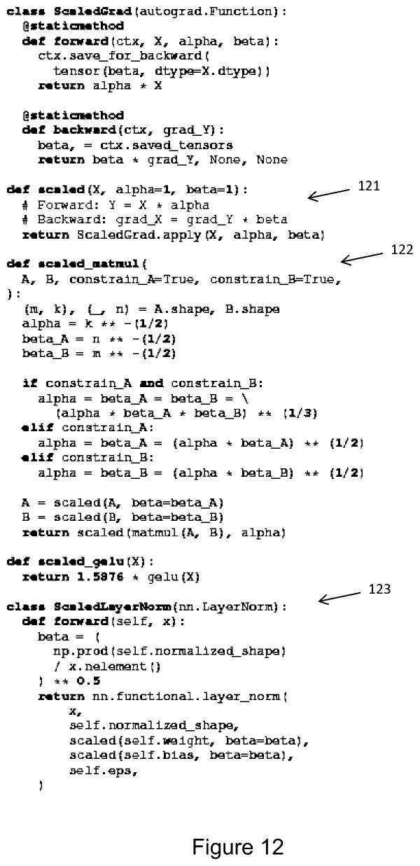

FIG. 12 also illustrates example code for constructing unit-scaled models in PyTorch. The scaled function 121 is the basic building block of unit-scaled models. It enables independent control of forward and backward pass scaling factors, and as such must be used with care—it could be used to define a scaled graph with incorrect constraints, leading to gradients that are inconsistent with the forward pass of the model. The scaled matmul function 122 demonstrates how to combine multiple constraints using the geometric mean. scaled gelu implements only fully constrained scaling for brevity. When scales are fully constrained, custom gradients via scaled are optional. Note that it may still be useful in certain situations for improving the scale of intermediate values. The class ScaledLayerNorm 123 uses the usual assumption for scaled layers: weights are cut-edges, activations are not. This permits independent scales for the weight and bias parameters.

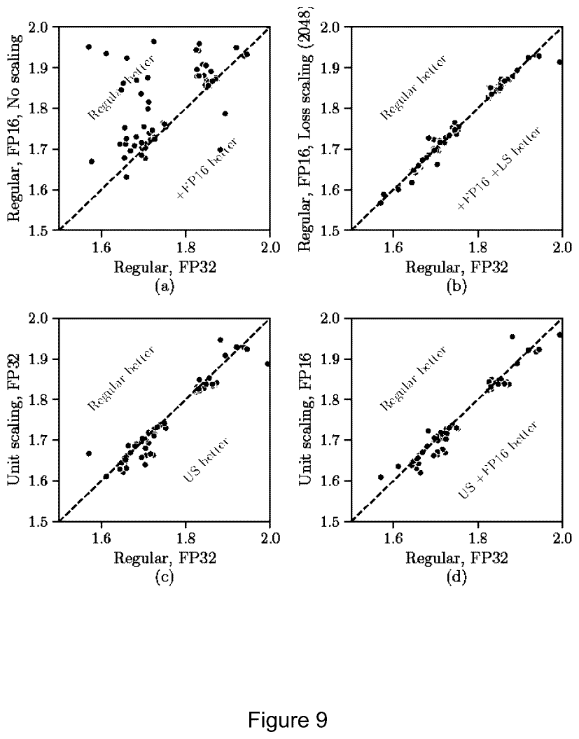

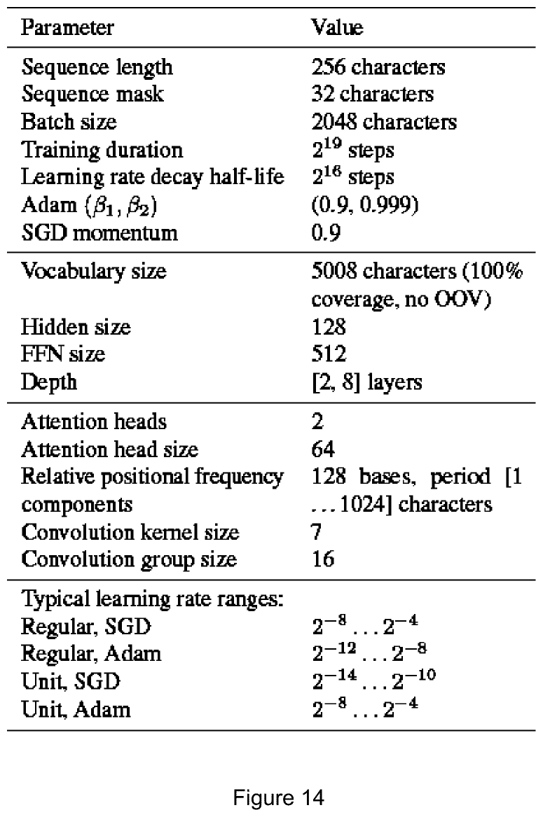

FIG. 9 illustrates performance of models trained using unit scaling on an example task. In particular, the graphs illustrate the performance of unit scaling for multiple model architectures and optimisers on a WikiText-103 raw character language modelling task. The task is discussed in Stephen Merity, Caiming Xiong, James Bradbury, and Richard Socher. Pointer sentinel mixture models. 5^{th} International Conference on Learning Representations, 2017. The models are causal language models trained using cross entropy loss during training, and are evaluated on bits per character (BPC). Each point on each graph represents a particular combination of sequence layer type, norm placement and residual scaling, and represents the best final value over a learning rate sweep. All of the models follow the pattern of a Transformer decoder layer. The sequence layer type is one of: Attention, RNN and Convolution. The norm placement is one of: PreNorm, PostNorm and NoNorm. The residual scaling is one of: default, fixed and running-mean (as defined hereinabove). Over the product of these settings, the performance of regular (baseline) and unit scaling in both FP32 and FP16 is compared. For this, the regular model in FP16 with loss scaling is also evaluated. The full hyperparameters used in these experiments are shown in FIG. 14.

The above combinations of configurations amount to a 2092-run sweep. First, these results demonstrate the need for scaling when using FP16. This is due to gradient underflow, since loss scaling with a factor of 2048 resolves the issue. Second, they demonstrate that unit scaling, despite changing the training behaviour of the model beyond just numerics, matches or even slightly improves upon baseline performance in almost all cases. Finally, they show that no tuning is necessary when switching unit scaling to FP16.

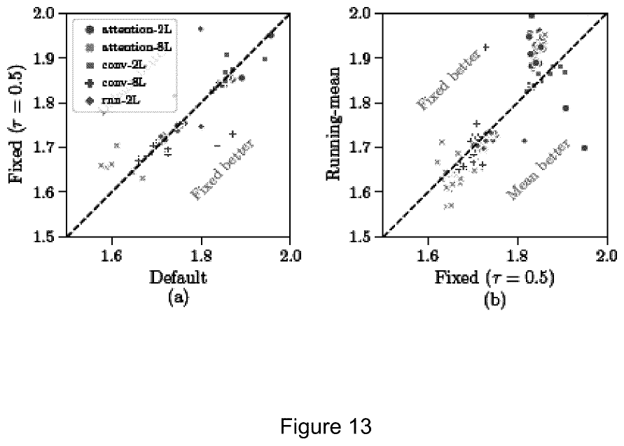

The effect of using different residual scaling schemes is also explored, with results shown in FIG. 13. These results show that performance is not sensitive to the choice of scheme, and suggest that running-mean or fixed are reasonable choices when using unit scaling.

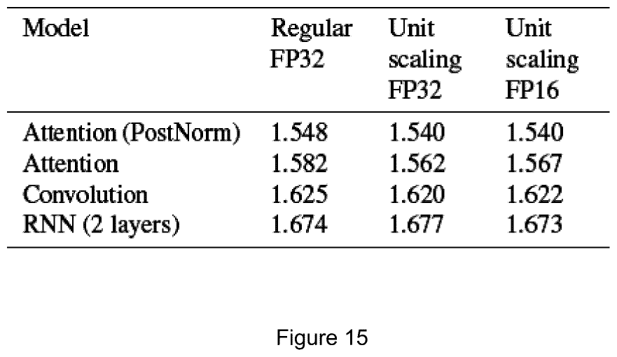

Furthermore, FIG. 15 illustrates further results on the character language modelling task, which further demonstrate that unit-scaled models perform comparably to regular models, and can be trained in FP16 without modification or additional hyperparameter selection.

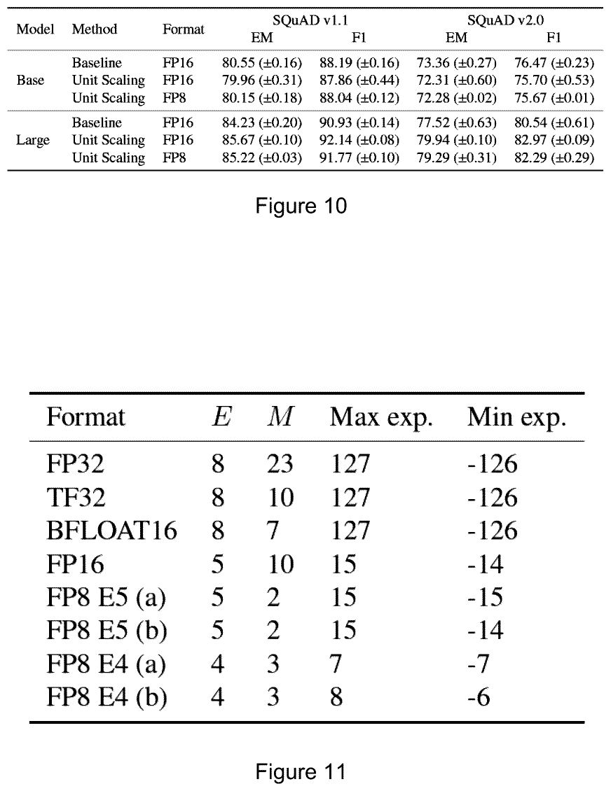

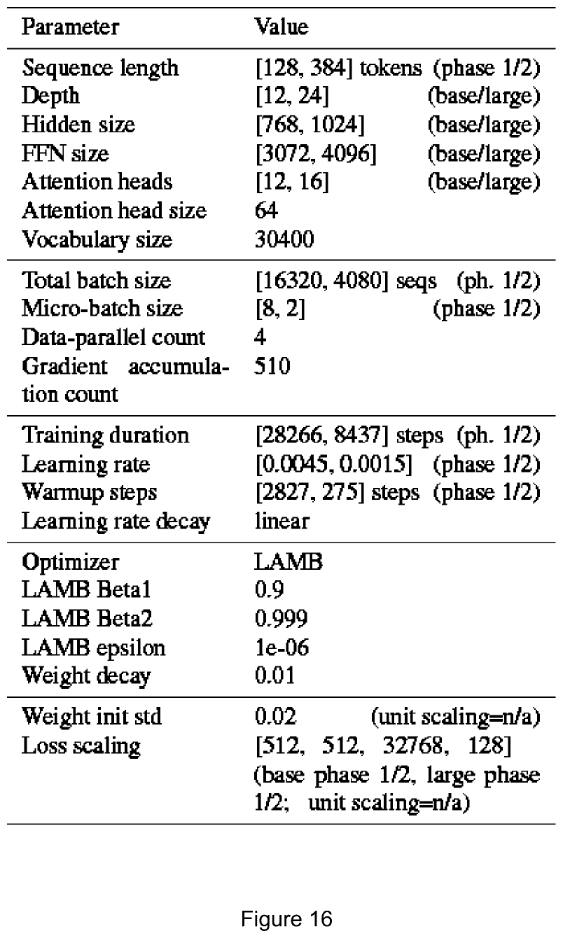

FIG. 10 illustrates further evaluation of the unit scaling techniques discussed herein on a masked language modelling task. The standard BERT (Jacob Devlin et al, BERT: Pre-training of Deep Bidirectional Transformers for Language Understanding, NAACL-HLT, 2019) masked language model pretraining objective is used over English Wikipedia articles, and downstream performance is demonstrated on SQuAD vi.1 and SQuAD v2.0 (see https://rajpurkar.github.io/SQuAD-explorer/). Both BERT_{BASE} and BERT_{LARGE} models are trained for the evaluation. F1 represents the F1 score, and EM is the exact match—a measure of the percentage of predictions that match any one of the ground truth answers exactly. FIG. 16 illustrates the hyperparameters used in the task in more detail.

For each model-method-format combination in the table, 3 models are trained, then 5 fine-tune runs are carried out for each of SQuAD v1.1 and SQuAD v2.0, to give a total of 15 runs per downstream task. The values shown represent the mean across the 15 runs, with ±representing the standard deviation across the means scores of the 3 sub-groups. The results show that in FP16, the substantially same performance can be obtained with unit scaling. For FP8, there is no degradation relative to FP16.

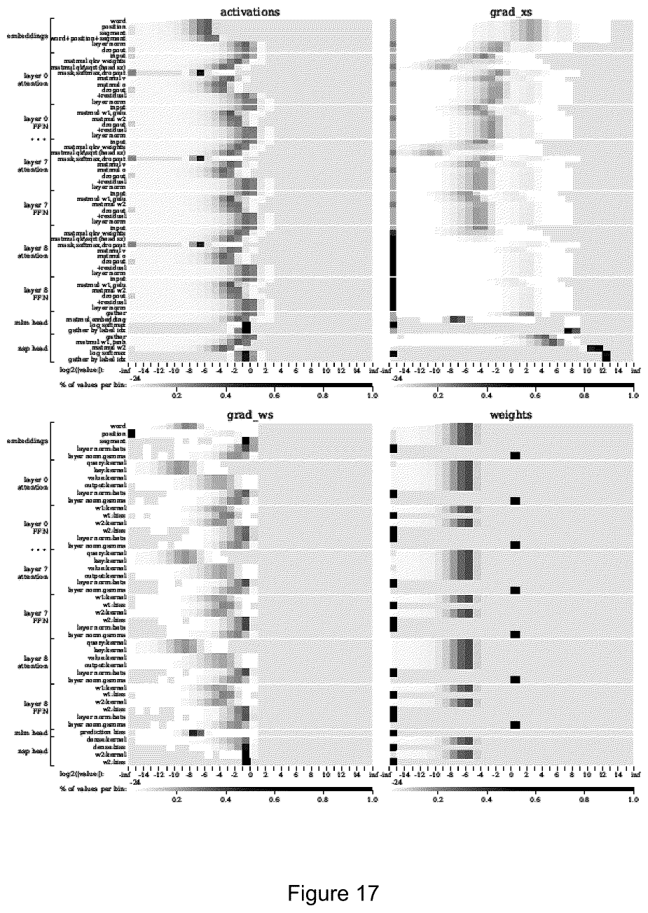

FIGS. 17-20 are histograms reflecting the absolute tensor values for FP16 BERT_{BASE} models.

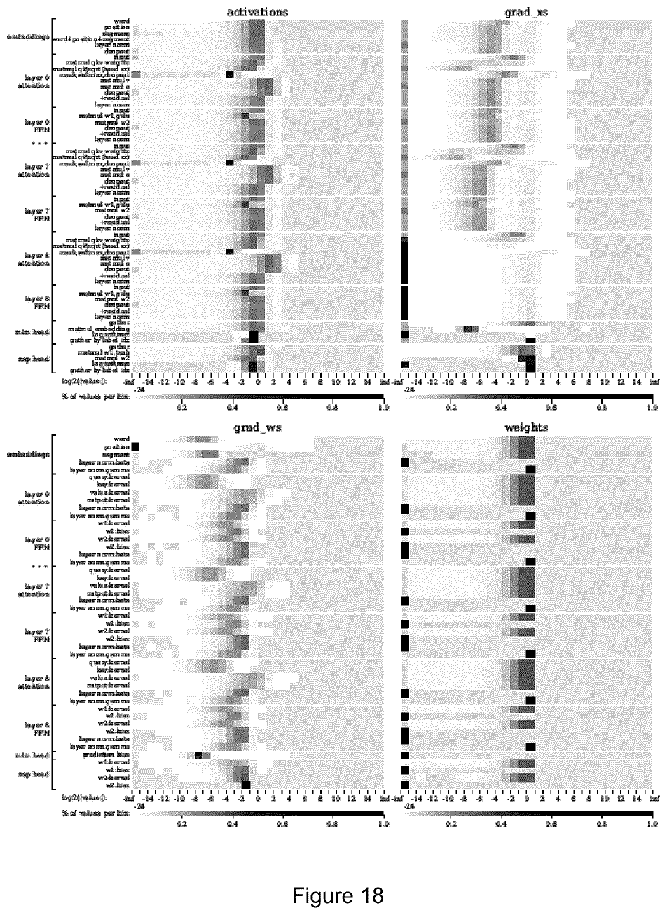

FIG. 17 shows the tensor values at the beginning of a training process for a model trained using loss scaling. Here a loss scale of 2¹⁵ was required for stable training. We can understand loss scaling in light of this plot as enacting a shift of the gradx and gradw histograms by log₂(loss scale) to the right. FIG. 18 shows the tensor values at the beginning of the training process for a model trained using the unit scaling techniques discussed herein. The first two figures can be understood as the full-model equivalent to the plot in FIG. 2B.

A comparison between these two figures illustrates the effectiveness of unit scaling. Whereas the loss-scaled model has to tune a hyperparameter to centre the two gradient sub-plots (grad_xs, grad_ws), the unit scaled model does this naturally. Furthermore, values in the unit-scaled model are typically closer to the centre of the range. The loss scaling approach also has the problem of very large gradx values in its NSP (next sentence prediction) and MLM (masked language modelling) heads.

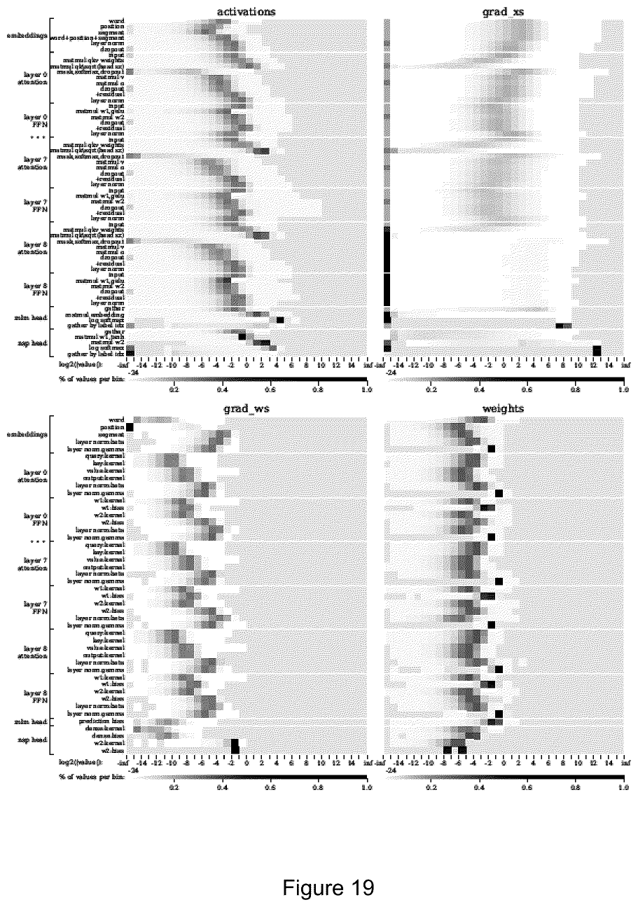

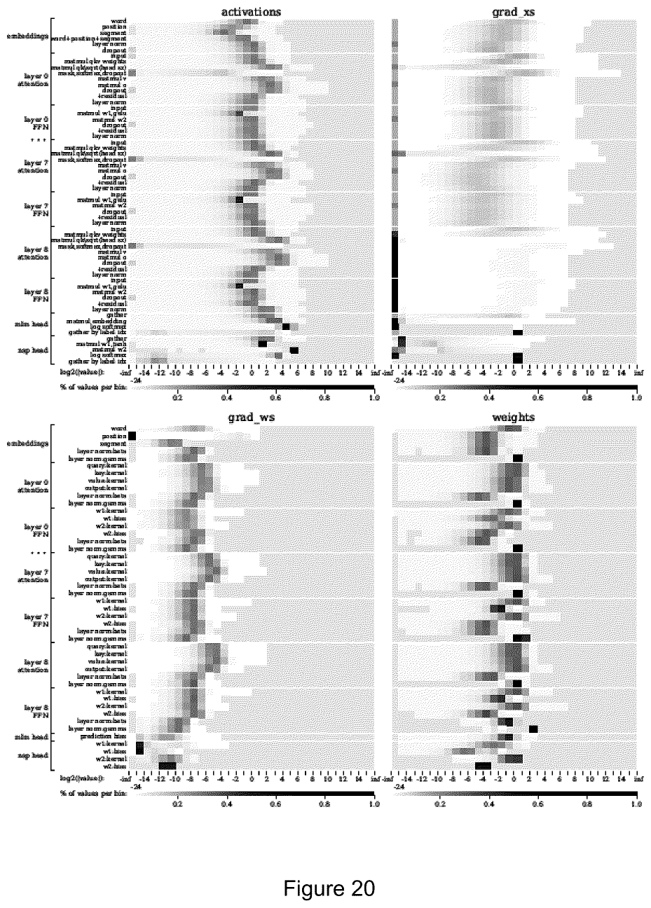

FIGS. 19-20 respectively showing how values shift as a result of training for the loss scaled and unit scaled models.

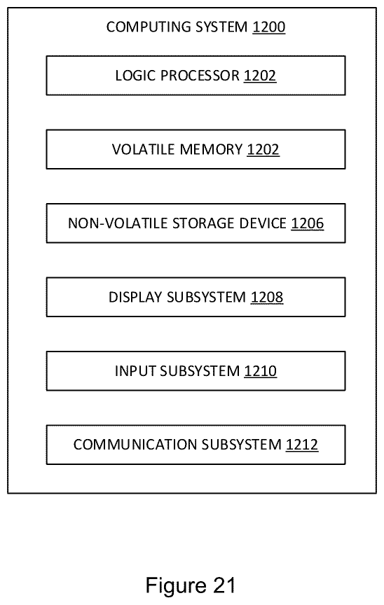

FIG. 21 schematically shows a non-limiting example of a computing system 1200 that can enact one or more of the methods and processes described above. Computing system 1200 is shown in simplified form. Computing system 1200 may embody any of the computing systems 100, 200, or 300 described above. Computing system 1200 may take the form of one or more personal computers or server computers.

Computing system 1200 includes a logic processor 1202, volatile memory 1204, and a non-volatile storage device 1206. Computing system 1200 may optionally include a display subsystem 1208, input subsystem 1210, communication subsystem 1212, and/or other components not shown in FIG. 21.

Logic processor 1202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 1202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1206 includes one or more physical devices configured to hold instructions executable by the logic processors to implement the methods and processes described herein. When such methods and processes are implemented, the state of non-volatile storage device 1206 may be transformed e.g., to hold different data.

Non-volatile storage device 1206 may include physical devices that are removable and/or built-in. Non-volatile storage device 1206 may include optical memory (e g., CD, DVD, HD-DVD, Blu-Ray Disc, etc), semiconductor memory (e g., ROM, EPROM, EEPROM, FLASH memory, etc.), and/or magnetic memory (e.g., hard-disk drive, floppy-disk drive, tape drive, MRAM, etc.), or other mass storage device technology. Non volatile storage device 1206 may include nonvolatile, dynamic, static, read/write, read-only, sequential-access, location-addressable, file-addressable, and/or content-addressable devices. It will be appreciated that non-volatile storage device 1206 is configured to hold instructions even when power is cut to the non-volatile storage device 1206.

Volatile memory 1204 may include physical devices that include random access memory. Volatile memory 1204 is typically utilized by logic processor 1202 to temporarily store information during processing of software instructions. It will be appreciated that volatile memory 1204 typically does not continue to store instructions when power is cut to the volatile memory 1204.

Aspects of logic processor 1202, volatile memory 1204, and non-volatile storage device 1206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example. As discussed above, the computer system 1200 may form part of a multi-tile processing device. There are many possible different manifestations of a suitable processing device, which may take the form of a chip. Graphcore have developed an intelligence processing unit (IPU) which is described for example in US patent applications numbers: US 2019/0121387 A1; US 2019/0121388 A1; US 2019/0121777 A1; US 2020/0319861 A1 the contents of which are herein incorporated by reference.

The terms “module,” “program,” and “engine” may be used to describe an aspect of computing system 1200 typically implemented in software by a processor to perform a particular function using portions of volatile memory, which function involves transformative processing that specially configures the processor to perform the function. Thus, a module, program, or engine may be instantiated via logic processor 1202 executing instructions held by non-volatile storage device 1206, using portions of volatile memory 1204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1208 may be used to present a visual representation of data held by non-volatile storage device 1206. The visual representation may take the form of a graphical user interface (GUI). As the herein described methods and processes change the data held by the non-volatile storage device, and thus transform the state of the non-volatile storage device, the state of display subsystem 1208 may likewise be transformed to visually represent changes in the underlying data. Display subsystem 1208 may include one or more display devices utilizing virtually any type of technology. Such display devices may be combined with logic processor 1202, volatile memory 1204, and/or non-volatile storage device 1206 in a shared enclosure, or such display devices may be peripheral display devices.

When included, input subsystem 1210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1212 may be configured to communicatively couple various computing devices described herein with each other, and with other devices. Communication subsystem 1212 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1200 to send and/or receive messages to and/or from other devices via a network such as the internet.

Further aspects of the disclosure and relevant optional features are set out in the statements below. These statements can be combined in any combination. That is to say, it is expressly intended each of the statements may depend upon any of the other statements.

According to one aspect of the disclosure, there is provided a machine learning system implementing a machine learning model, the system comprising: at least one layer of processing nodes, each processing node comprising a processor configured to execute computer readable instructions to perform at least one operation based on one or more inputs received at the processing node, wherein the at least one operation is scaled by a first scaling factor which has been calculated to cause a variance of an output of the at least one operation to have a target variance.

The target variance may be a unit variance. The target variance may be a variance which matches a variance of the one or more inputs.

The at least one operation is implemented in a forward pass of the machine learning model. The system may be configured to perform a training process to train the machine learning model, and the forward pass forms part of the training process. The system may be configured to perform an inference process. The forward pass may form part of the inference process.

The processing nodes may be configured to determine a gradient of a loss function in a backward pass of the machine learning model through the layer by carrying out a gradient calculation in a gradient operation. The gradient operation may be scaled by a second scaling factor to generate outputs with a second target variance.

The one or more inputs may comprise weights, and the gradient calculation may be performed with respect to the weights. The one or more outputs may comprise activations and the gradient calculation may be performed with respect to the activations.

Any inputs, outputs (e.g. weights and/or activations) discussed herein may be tensors.

The inputs may comprise a set of input activations and a set of weights, and the outputs may comprise a set of output activations. The inputs may comprise a set of input gradients and a set of weights and/or activations, and the outputs may comprise a set of output gradients.

There may be a gradient calculation for weights and a gradient calculation for activations. The gradient operation for weights may use a different scaling factor than the gradient operation with respect to activations. One goal of the disclosed technique is to produce a set of rules for a fixed scaling of operations in the forward and backward pass, in order to maintain the variance of the output of each operation to match a target variance, for example to be approximately equal to the variance of the input of that operation. This set of fixed scaling rule can be applied both at initialization and during training, on their own or in conjunction with alternative techniques for automatic scaling of signals in the forward and backward pass (e.g., U.S. patent application Ser. No. 18/066,530 (Automatic Loss Scaling) and U.S. patent application Ser. No. 18/066,627 (Automatic Exponent Bias Selection), the contents of which are incorporated by reference.

In certain embodiments the system constrains the input and output distribution to have approximately unit variance (‘Unit Scaling’), but the approach can be generally extended to approximately maintaining for each operation a value of the input and output variance different from one.

In one example, considering a fully connected layer of a neural network, with input activations X∈ [symbol] ^{b×m} with zero mean and variance σ_{X}² and weights W∈ [symbol] ^{m×n} with zero mean and variance σ_{W}², the layer output would be given by Z=XW, with Z∈ [symbol] ^{b×n}. The values of Z follow Zᵢₖ=ΣⱼXᵢⱼWⱼₖ, which is a sum over m products, each with variance of σ_{X}²σ_{W}². Therefore, by the product of uncorrelated variables and the variance of an independent sum, the output variance is given by σ_{Z}²=mσ_{X}²σ_{W}².

In this case, if X and W are unit variance, to maintain unit variance at the output it would be enough to scale Z by α=1/\sqrt{m}.

For the backward pass of the same layer, computing the gradient of the loss [symbol] with respect to the activations X one obtains ∇× [symbol] =∇_{Z} [symbol] W^{T}. Then, assuming that ∇_{Z} [symbol] is zero mean and variance σ_{∇}_{_{Z}}², by the same reasoning as above the variance of ∇_{X} [symbol] is written as σ_{∇}_{_{X}}²=nσ_{∇}_{_{Z}}²σ_{∇}_{_{W}}². Therefore, to maintain unit variance at the output ∇_{X} [symbol] in the backward pass it would be enough to scale ∇_{X} [symbol] by β₁=1/\sqrt{n}.

Similarly, for the gradient if the loss [symbol] with respect to the weights W, the variance of ∇_{W} [symbol] is given by σ_{∇}_{_{W}}²=bσ_{∇}_{_{Z}}²σ_{∇}_{_{X}}². As a consequence, to maintain unit variance at the output ∇_{W} [symbol] in the backward pass it would be enough to scale ∇_{W} [symbol] by β₂=1/\sqrt{b}.

The scaling factors may be constrained. For example, the scaling factor used in operations on the forward pass may be constrained to be equal to a scaling factor used for scaling the gradient calculation operations on the backwards pass. In certain embodiments, only one of the gradient operations has its scaling factor constrained, while the other is determined by computation.

The scaling factors may be calculated for some or all of operations to be carried out in the neural network. In particular, it may be determined which operations have an effect on the variance of the outputs relative to the inputs, and apply a scaling factor only to those operations.

Constraints on scaling factors may be applied only on non-cut edges of a computational graph used to construct the machine learning model, and not to cut edges.

For the example of a fully connected layer described above, in the typical case the projection operation is in a residual block within a shortcut connection. In this situation, the edge connecting the weights W is a cut edge, while the edge connecting the inputs X is not a cut edge. Given this assumption, the techniques herein may constrain the forward pass activations scale α and the backward pass gradient with respect to activations β₁ to be equal, which is implemented by setting both to the geometric mean of their unconstrained values:

$$α = {β}_{1} = {( m \cdot n )}^{- \frac{1}{4}} .$$

For the backward pass gradient with respect to the weights, the techniques herein may instead leave the scale β₂ unchanged.

The system may be configured to execute a computational graph. The computational graph may comprise: a plurality of graph nodes corresponding to computational operations, and a plurality of graph edges corresponding to inputs and outputs of the graph nodes. The at least one operation may correspond to a graph node of the plurality of graph nodes of the computational graph.

The system may be configured to store the inputs and/or outputs in a floating-point number representation, which may comprise 16 bits or fewer.

According to another aspect of the disclosure, there is provided a computer-implemented method comprising: receiving a computational graph, the computational graph comprising: a plurality of nodes, each node of the plurality of nodes corresponding to a computational operation for training a machine learning model, and a plurality of edges, each edge connecting a pair of the nodes and corresponding to an output of a first node of the pair of the nodes and an input to a second node of the pair of the nodes; and inserting a first scaling factor into the computational graph associated with at least one node of the plurality of nodes, the first scaling factor calculated to cause a variance of an output of the at least one node to have a target variance.

The computational operation may be selected from one of a plurality of computational operations, which may be predetermined. The first scaling factor may be selected based on the selected computational operation. The computational operation and/or scaling factor may be any of those set out in FIG. 3. The first scaling factor may be based on an assumed statistical distribution of inputs to the selected computational operation.

The first scaling factor may be a forward scaling parameter multiplied with an output of the computational operation of the at least one node to cause the variance to have the target variance.

Each node may comprise a second scaling factor, the second scaling factor being a backward scaling parameter multiplied with a result of a gradient operation applied to the node.

A subset of the edges may be cut edges, the cut edges being edges that if cut disconnect the pair of nodes connected by the cut edge such that there is no other path between the pair of nodes in the computational graph.

The method may further comprise: identifying edges other than the cut edges; and setting the second scaling factor of nodes connected by edges other than the cut edges equal to the first scaling factor.

The method may comprise receiving, via a user interface, user input. The user input may identify the cut edges. The user input may comprise the first scaling factor, or second scaling factor. The user input may comprise the selection of one or more initialisation distributions for parameters of the model, and/or identification of cut-edge constraints and/or selection of one or more weighting hyperparameters for weighted add operations and/or selection of one or more per-parameter optimiser step size modifiers, used to scale the global optimiser step size hyperparameter.

According to another aspect, there is provided a non-transitory computer-readable medium comprising computer-executable instructions, the instructions when executed implementing a neural network, wherein the instructions comprise first code embodying at least one scaled operation configured to receive a tensor of weights and a tensor of input activations and to generate a tensor of output activations with a target variance. The target variance may be unit variance.

According to one aspect of the disclosure, there is provided a machine learning system implementing a machine learning model, the system comprising at least one layer of processing nodes, each processing node comprising a processor configured to execute computer readable instructions and to receive a set of input activations and a set of weights and to perform at least one operation to generate a set of output activations, wherein the operation is scaled by a scaling factor which has been calculated to cause the variance of the set of output activations generated by the operation to have a target variance.

According to another aspect of the disclosure, there is provided a machine learning system implementing a machine learning model, the system comprising at least one layer of processing nodes, each processing node comprising a processor (e.g. one or more processing units) configured to execute computer readable instructions and to receive a set of input activations and a set of weights and to perform at least one operation to generate a set of output activations, wherein the operation is scaled by a scaling factor which has been calculated to cause the set of output activations generated by the operation to have a unit variance.

According to another aspect of the disclosure, there is provided a machine learning system implementing a machine learning model, the system comprising at least one layer of processing nodes, each processing node comprising a processor (one or more processing units) configured to execute computer readable instructions and to receive a set of input activations and a set of weights and to perform at least one operation to generate a set of output activation, wherein the operation is scaled by a scaling factor which has been calculated to cause the variance of the set of output activations generated by the operation to have a variance which matches the variance of the set of input activations.

Another aspect of the disclosure provides a method of generating a computer program for implementing a machine learning model (such as a neural network), wherein the computer program comprises first code embodying at least one scaled operation configured to receive a tensor of weights and a tensor of activations and to generate a tensor of output activations with unit variance or a variance matching the variance of the inputs.

The computer program may also comprise second code for implementing one or more scaled gradient calculation for effecting a backward pass of the machine learning model, wherein the or each gradient calculation has a scaling factor applied to them to generate outputs with a unit variance or a variance matching the variance of the inputs.

Another aspect of the disclosure comprises a computer program in the form of transitory or non-transitory computer executable instructions, the computer program implementing a machine learning model (such as a neural network) when executed wherein the computer program comprises first code embodying at least one scaled operation configured to receive a vector of weights and a vector of activations and to generate a vector of output activations with unit variance or a variance matching the variance of the inputs.

The computer program may also comprise second code for implementing one or more scaled gradient calculation for effecting a backward pass of the machine learning model, wherein the or each gradient calculation has a scaling factor applied to them to generate outputs with a unit variance or a variance matching the variance of the inputs.

The term “unit variance” is used herein in its standard statistical meaning to indicate the square value of the standard deviation of a set of samples which tends towards 1 (unity) as the sample size tends towards infinity. The variance is determined by the expected value of the square difference between the samples and the mean of the distribution, which is practically estimated by computing the sum of the squared differences between the estimated mean of the sample distribution and an actual sample value, divided by the total number of samples in the distribution.

When the model is trained, the inputs to the model may be constrained to have unit variance.

The model may have multiple layers, with the outputs of one layer feeding a subsequent layer.

Whilst the aspects set out above and the discussion above relates to the scaling of operations that generate output activations, it will be appreciated that these concepts may also be applied to different operations that may be carried out in the context of neural networks, such as deep neural networks. For example, the concept may be applied to operations carried out in an attention layer, such as those that involve the multiplication of different projections of the input activations. It may also be applied to the generation of weights and/or gradients.

Accordingly, in another aspect of the disclosure, there is provided a machine learning system implementing a machine learning model, the system comprising at least one layer of processing nodes, each processing node comprising a processor configured to execute computer readable instructions to perform at least one operation based on one or more inputs received at the processing node, wherein the operation is scaled by a scaling factor which has been calculated to cause the variance of the output of the operation to have a target variance.

Any of the methods defined herein may be provided as computer systems or computer-readable media with corresponding features, and vice-versa.

1. A machine learning system implementing a machine learning model, the system comprising:
at least one layer of processing nodes, each processing node comprising a processor configured to execute computer readable instructions to perform at least one operation based on one or more inputs received at the processing node,
wherein the at least one operation is scaled by a first scaling factor which has been calculated to cause a variance of an output of the at least one operation to have a target variance.

2. The system of claim 1, wherein the target variance is a unit variance.

3. The system of claim 1, wherein the target variance is a variance which matches a variance of the one or more inputs.

4. The system of claim 1, wherein the at least one operation is implemented in a forward pass of the machine learning model.

5. The system of claim 4, wherein the system is configured to perform a training process to train the machine learning model, and the forward pass forms part of the training process.

6. The system of claim 4, wherein system is configured to perform an inference process, and the forward pass forms part of the inference process.

7. The system of claim 1, wherein the processing nodes are configured to determine a gradient of a loss function in a backward pass of the machine learning model through the layer by carrying out a gradient calculation in a gradient operation,
wherein the gradient operation is scaled by a second scaling factor to generate outputs with a second target variance.

8. The system of claim 7, wherein the one or more inputs comprise weights, and the gradient calculation is performed with respect to the weights.

9. The system of claim 7, wherein the one or more outputs comprise activations and the gradient calculation is performed with respect to the activations.

10. The system of claim 1, wherein the inputs and outputs are tensors.

11. The system of claim 1, wherein the inputs comprise a set of input activations and a set of weights, and the outputs comprise a set of output activations.

12. The system of claim 1, wherein the inputs comprise a set of input gradients and a set of weights and/or activations, and the outputs comprise a set of output gradients.

13. The system of claim 1, wherein the machine learning system is configured to execute a computational graph, the computational graph comprising:
a plurality of graph nodes corresponding to computational operations, and
a plurality of graph edges corresponding to inputs and outputs of the graph nodes;
wherein the at least one operation corresponds to a graph node of the plurality of graph nodes of the computational graph.

14. The system of claim 1, wherein the system is configured to store the inputs and/or outputs in a floating-point number representation comprising 16 bits or fewer.

15. A computer-implemented method comprising:
receiving a computational graph, the computational graph comprising:
a plurality of nodes, each node of the plurality of nodes corresponding to a computational operation for training a machine learning model, and
a plurality of edges, each edge connecting a pair of the nodes and corresponding to an output of a first node of the pair of the nodes and an input to a second node of the pair of the nodes;
inserting a first scaling factor into the computational graph associated with at least one node of the plurality of nodes, the first scaling factor calculated to cause a variance of an output of the at least one node to have a target variance.

16. The method of claim 15, wherein the computational operation is selected from one of a plurality of computational operations, and the first scaling factor is selected based on the selected computational operation.

17. The method of claim 16, wherein the first scaling factor is selected based on an assumed statistical distribution of inputs to the selected computational operation.

18. The method of claim 15, wherein:
the first scaling factor is a forward scaling parameter multiplied with an output of the computational operation of the at least one node to cause the variance to have the target variance;
each node comprises a second scaling factor, the second scaling factor being a backward scaling parameter multiplied with a result of a gradient operation applied to the node;
a subset of the edges are cut edges, the cut edges being edges that if cut disconnect the pair of nodes connected by the cut edge such that there is no other path between the pair of nodes in the computational graph;
the method further comprising:
identifying edges other than the cut edges;
setting the second scaling factor of nodes connected by edges other than the cut edges equal to the first scaling factor.

19. The method of claim 18, comprising:
receiving, via a user interface, user input identifying the cut edges.

20. The method of claim 15, comprising:
receiving, via a user interface, the first scaling factor.

21. A non-transitory computer-readable medium comprising computer-executable instructions, the instructions when executed implementing a neural network,
wherein the instructions comprise first code embodying at least one scaled operation configured to receive a tensor of weights and a tensor of input activations and to generate a tensor of output activations with a target variance.

22. The non-transitory computer-readable medium of claim 21, wherein the target variance is unit variance.
